(19) United States
(12) Patent Application Publication
(10) Pub. No.: US 2009/0211507 A1
(43) Pub. Date: Aug. 27, 2009

(54) SYSTEM AND METHOD FOR THE COLLECTION AND DISPOSAL OF BALLAST WATER, BILGE WATER AND WASTE WATER

(76) Inventors: Ian Fielding, Niagara Falls (CA); John Moriarty, Moonstone (CA); Randy Gillen, St. Catherines (CA)

Correspondence Address: DIMOCK STRATTON LLP, 20 QUEEN STREET WEST SUITE 3202, BOX 102, TORONTO, ON, M5H 3R3, CA

(21) Appl. No.: 12/036,866

(22) Filed: Feb. 25, 2008

(51) Int. Cl. B63B 39/03; C02F 1/00

(52) U.S. Cl. 114/125; 210/241

(57) ABSTRACT

A method for removing ballast water to trim a vessel. The method comprises connecting a mobile reservoir in fluid connection with at least one ballast reservoir of the vessel. After connection the ballast may be transferred water from the at least one ballast reservoir to the mobile water removal reservoir. The mobile reservoir may be disconnected from the at least one ballast reservoir. The ballast water in the mobile water removal reservoir may be tested for contaminants. There is also a method of handling vessel ballast water. A first authority may transfer first authority certified water to a ballast of a vessel. A second authority may transfer ballast water from the vessel and verify that the ballast water comprises first authority certified water.

### FIELD OF THE INVENTION

This invention relates to the field of vessel ballast water, bilge water and/or waste water collection and disposal. More specifically, this method relates to a system and method for vessel ballast water, bilge water and/or waste water collection and disposal that minimizes the risk of untreated water being exposed to the environment.

### BACKGROUND OF THE INVENTION

Ballast water is carried by vessels to provide stability and trim. As a vessel loads or offloads cargo, or takes on or consumes fuel, the vessel must accommodate changes to its displacement and trim by taking on or discharging ballast water. Ballast water up-take and discharge often occurs in port during cargo operations or fuel replenishment, but also takes place while a vessel is in transit.

When vessels up-take ballast water contaminants such as nuisance species including, but not limited to, small organisms, aquatic plants, plankton, seeds and sediment suspended in the water may be captured in the ballast water and transported, often in a viable condition, across natural biological barriers to a remote location and released. In some circumstances the remote location has no natural defence to the transported species which becomes invasive and disrupt, degrade or destroy elements unique to the remote environment.

The risk of disruption to or degradation or destruction of the natural environment, the man-built infrastructure and the human population is not limited solely to the release of nuisance species but contaminants may also include the release of dangerous substances. When vessels up-take ballast water, dangerous substances may be inadvertently or negligently captured in the ballast water. More troubling, dangerous substances may be deliberately (surreptitiously or otherwise) introduced into the ballast water. Such dangerous substances could then be transported (knowingly or unknowingly) to a remote location and released causing catastrophic disruption to or degradation or destruction of the natural environment, the man-built infrastructure and/or the human population in the remote location.

Ships fully loaded with cargo, commonly referred to as NOBOB's (No Ballast On Board), are rarely completely empty of ballast water. The residual ballast water in the onboard ballast reservoir is typically a mixture of water and sediment from recently visited ports. Upon calling at a port to empty its cargo, a NOBOB typically takes on ballast water to offset the cargo being unloaded. The uptake of ballast water re-suspends the sediment in the ballast water resulting in the discharge of the sediment when the ballast water is next discharged.

The Marine Environment Protection Committee at the International Maritime Organization (IMO) has established international ballast water management policy and best practice guidelines which include a ballast water discharge standard. Currently it is recommended that vessels either exchange ballast in mid-ocean to remove sediments, or under controlled arrangements in port or dockside. The mid-ocean exchange is recommended, since near-costal species generally do not survive in the ocean due to the change in water salinity as well as other environmental factors. Unfortunately, however, the mid-ocean exchange is not always practical depending upon the amount of cargo carried by a vessel, as well as the weather conditions at the time of transit. Furthermore, many vessels are not equipped to carry out a mid-ocean ballast exchange that will remove all sediment from their ballast reservoirs.

As a practical matter it is the local port state or authority that has a greater stake in ensuring that neither nuisance species nor dangerous substances are released into its local environment. Accordingly proposals have been made to provide ballast water treatment facilities in ports to provide for the controlled collection and disposal of ballast water. IMO has acknowledged that the development of port-based reception and treatment facilities is a reasonable option for the purpose of controlling ballast water. The provision of a port-based ballast water treatment facility, as opposed to individual vessel-based treatment facilities, makes logical sense for several reasons.

First, the capital cost of outfitting each vessel in the global commercial fleet with ballast water treatment equipment would be significantly higher compared with the capital cost of constructing treatment facilities at each of the world's commercial ports.

Second, vessel-based treatment equipment does not enable port states to monitor ballast water in any useful or secure manner. A network of port-based reception and treatment facilities would enable each port state (and IMO) the ability to catalogue the source, route, date and place of discharge, contents, treatment and disposition of ballast water transported by each vessel to each particular port.

Third, vessel-based treatment equipment does not enable port states to verify with any certainty or in any secure, documented manner that the ballast water discharged by a particular vessel has been properly treated (or treated at all) and that it is safe to be discharged into the environment. A network of port-based reception and treatment facilities would enable each port state the ability to sequester all ballast water received by it, to monitor its treatment, to verif and certif that it has been properly and completely treated and that it is safe to be discharged into the environment.

Fourth, unless the ship owner has made a capital investment in back-up equipment, if vessel-based treatment equipment becomes inoperable on a particular vessel, the ballast water transported by it could be discharged by it without proper treatment. A port-based reception and treatment facility, sized and configured to handle large volumes of ballast water from multiple vessels expected to enter the particular port, would have inherent redundancies in the event of the failure of individual treatment systems or their components.

Unfortunately, port states have been slow to adopt port-based treatment facilities due to many factors, including the lack of proven technology and the perceived difficulty of implementing a port-based treatment facility that fits into standard port operations and allows for the efficient loading and unloading of cargo. Accordingly there is a need for an improved system and method for removing ballast water to trim a vessel.

### BRIEF DESCRIPTION OF THE DRAWINGS

In drawings which illustrate by way of example only a preferred embodiment of the invention,

FIG. 1 is an illustration of a system embodiment.

FIG. 2 is an illustration of a method embodiment.

FIG. 3 is an illustration of a method embodiment.

FIG. 4 is an illustration of a method embodiment.

FIG. 5 is an illustration of a method embodiment.

FIG. 6 is an illustration of a method embodiment.

FIGS. 7a-c are illustrations of a method embodiment.

FIGS. 8a-8c are illustrations of a method embodiment.

FIGS. 9a-9b are illustrations of a method embodiment.

FIG. 10 is an illustration of a method embodiment.

### DETAILED DESCRIPTION OF THE INVENTION

The present invention provides for a system and method for transferring ballast water to trim a vessel. The system and method provides flexibility to minimally impair a vessel's operations, and still safeguard the environment. While the method predominantly considers ballast water other vessel waste water including bilge water may be handled and treated according to these methods.

The system and method employs mobile reservoirs to receive ballast water from vessels and sequester the ballast water until treatment. The use of mobile reservoirs allows vessel cargo operations to proceed normally, without being limited by the ability of a shore-based or mobile treatment facility to process the ballast water.

The system and method also allows for a zero discharge/uptake environment in which vessels may not be allowed to either discharge ballast water into or up-take ballast water from a body of water. In such an environment, vessels may be provided with treated water for ballast to avoid the uptake of nuisance species from a body of water. Local regulators find a zero discharge/up-take environment attractive as they are able to seal a vessel's ballast equipment, rather than relying upon a vessel operator not to discharge ballast water into a local body of water.

In an embodiment there is provided a method for removing ballast water to trim a vessel, the method comprising connecting a mobile reservoir in fluid connection with at least one ballast reservoir of the vessel; transferring ballast water from the at least one ballast reservoir to the mobile water removal reservoir; disconnecting the mobile reservoir from the at least one ballast reservoir; and, connecting the mobile reservoir in fluid communication to a water transfer connection to transfer the ballast water for treatment; whereby the transfer of ballast water from the at least one ballast reservoir trims the vessel.

The method may further comprise after disconnecting the mobile reservoir from the at least one ballast reservoir, repositioning the mobile reservoir to the water transfer connection for connection.

Alternatively, the method may further comprise after connecting the mobile reservoir to the water transfer connection, transferring the ballast water from the mobile reservoir to a treatment station for treatment.

In an alternate embodiment, there may be provided a method for removing ballast water to trim a vessel, the method comprising, connecting a mobile reservoir in fluid connection with at least one ballast reservoir of the vessel; transferring ballast water from the at least one ballast reservoir to the mobile water removal reservoir, disconnecting the mobile reservoir from the at least one ballast reservoir; testing the ballast water for contaminants; connecting the mobile reservoir in fluid communication to a water transfer connection; transferring the ballast water from the mobile reservoir to a treatment station for treatment; and, treating the ballast water in accordance with the results of the testing to produce treated water.

Alternately, there may be provided a method for adding ballast water to trim a vessel, the method comprising, connecting a mobile reservoir containing ballast water in fluid connection with at least one ballast reservoir of the vessel; transferring water from the mobile reservoir to the at least one ballast reservoir; and, disconnecting the mobile reservoir from the at least one ballast reservoir; whereby the transfer of water from the mobile reservoir to the at least one ballast reservoir trims the vessel. There may further be provided ballast water comprising treated water and the method further comprising filling the mobile reservoir with treated water at a water transfer connection and repositioning the mobile reservoir for connection to the vessel.

There may also be provided a system for handling vessel ballast water, the system comprising, one or more mobile reservoirs for receiving ballast water from a vessel; and, one or more ballast water transfer connections for fluid connection to the one or more mobile reservoirs to transfer ballast water from the one or more mobile reservoirs for treatment; whereby the one or more mobile reservoirs may be positioned to receive ballast water from the vessel.

The system may further comprise at least one water treatment station in fluid communication with the one or more ballast water transfer connections for receiving ballast water for treatment.

The at least one water treatment station may comprise at least one of: a liquid-solid separator for separating solid material from the ballast water, and a solids reservoir for storing the solids separated from the ballast water; a biological sterilizer for sterilizing, killing or eliminating biological matter in the ballast water; and, an oily water separator for separating oils from the ballast water, and an oils reservoir for storing the oils separated from the ballast water.

The system may further comprise: one or more mobile reservoirs for receiving treated water, and, one or more treated water transfer connections for fluid connection to the one or more mobile reservoirs to transfer treated water from the at least one water treatment station to the one or more mobile reservoirs.

There may be provided a method for handling ballast water used to trim vessels, the method comprising: connecting a mobile reservoir in fluid connection with at least one ballast reservoir of a vessel; transferring ballast water from the at least one ballast reservoir to the mobile water removal reservoir; disconnecting the mobile reservoir from the at least one ballast reservoir, repositioning the mobile reservoir to a water transfer connection for connection; connecting the mobile reservoir in fluid communication to a water transfer connection for transferral to a treatment station; transferring the ballast water to the treatment station; and, treating the ballast water at the treatment station for contaminants such as nuisance species and/or dangerous substances to produce treated water.

The method may further comprise transferring the treated water to a mobile reservoir connected to a treated water transfer connection in fluid communication with the treatment station. Additionally, the method may further comprise disconnecting the mobile reservoir from the treated water transfer connection; and, repositioning the mobile reservoir for fluid connection to at least one ballast reservoir of another vessel; and, transferring treated water from the mobile reservoir to the at least one ballast reservoir of the another vessel.

A method of handling vessel ballast water may comprise a first authority transferring first authority certified water to a ballast of a vessel; a second authority transferring ballast water from the vessel and verifying that the ballast water comprises first authority certified water. The first authority certified water may comprise traceable water and the second authority tests the traceable water. Alternatively, the method of claim may further comprise the first authority sealing the vessel's ballast controls and the second authority confirming the integrity of the seal.

There may be provided a method for handling vessel waste water, the method comprising connecting a reservoir in fluid connection with at least one waste water reservoir of a vessel; transferring waste water from the at least one waste water reservoir to the reservoir; disconnecting the reservoir from the at least one waste water reservoir; testing the waste water for contaminants; connecting the reservoir in fluid communication to a treatment station; transferring the waste water to the treatment station; and, treating the waste water at the treatment station for contaminants identified by the testing to produce treated water.

A system illustrated in FIG. I includes at least one mobile reservoir 100 for collecting ballast water from at least one ballast reservoir 15 on a vessel 10. The at least one mobile reservoir 100 allows for storage and sequestration of ballast water isolated from the environment. In an embodiment the mobile reservoir 100 comprises water transfer equipment 105, such as a pump, for transferring ballast water from a ballast reservoir 15 to the mobile reservoir 100. The mobile reservoir 100 may comprise a self-propelled mobile reservoir, or alternatively, may comprise a non-propelled mobile reservoir that may be repositioned with the aid of a propulsion unit (not shown). In an embodiment the mobile reservoir 100 may comprise a barge that may be re-positioned with the aid of a self-propelled craft such as a tugboat.

In an embodiment mobile reservoir 100 comprises a single reservoir for storing ballast water. In an alternate embodiment mobile reservoir 100 comprises multiple reservoirs for storing ballast water. In a further embodiment the multiple reservoirs comprise separately sequestered reservoirs to provide for independent sequestration of water. The multiple separately sequestered reservoirs may be used for storing and separately sequestering ballast water from multiple vessels. Alternatively, the multiple separately sequestered reservoirs may be used for storing and separately sequestering ballast water and treated water in a single mobile reservoir 100.

In use, a first mobile reservoir is preferably dedicated to handling ballast water and a second mobile reservoir is preferably dedicated to handling treated water. Where a mobile reservoir comprises multiple separately sequestered reservoirs, the same mobile reservoir may be described as comprising a first mobile reservoir and a second mobile reservoir.

The mobile reservoir 100 allows for the convenient transfer of ballast water from a vessel 10 without interfering with normal port operations. In an embodiment the mobile reservoir 100 comprises water transfer equipment 105 that is capable of transferring water from a ballast reservoir 15 at a minimum flow rate as fast as normal ship de-ballasting rates. In such an embodiment the mobile reservoir 100 provides a system and method for removing ballast water to trim a vessel that is transparent to the vessel operator. That is, the vessel operator is able to carry out their normal vessel operations, including the loading and offloading of cargo, while concurrently trimming their vessel.

After transfer of the ballast water from the ballast reservoir 15, the mobile reservoir 100 may store the ballast water or may immediately be connected to a water transfer connection 200 in order to transfer the ballast water to a treatment facility 300. The treatment facility 300 may be a fixed facility either on-shore, dockside, or located on a man-made island in a convenient location for vessel operations. Alternatively, the treatment facility 300 may comprise a mobile treatment facility 350 that may be repositioned as necessary to treat water stored in mobile reservoirs 100.

The mobile reservoir 100 may be used to store ballast water for a variety of reasons, including until the water has been tested, until convenient to be transferred to the treatment facility 300, or to provide for local discharge and storage of ballast water at a location lacking a proximate treatment facility 300. For instance a dock facility, such as a loading dock, grain elevator, or the like may be located distant from a port with a treatment facility 300. In such circumstances a mobile reservoir 100 may be used to collect ballast water near the dock facility and store it until convenient to transfer the ballast water to the treatment facility 300 either by repositioning the mobile reservoir 100 or by offloading the ballast water for transport to the treatment facility 300. Alternatively, a mobile water treatment facility 350 may be repositioned for connection to the mobile reservoir 100.

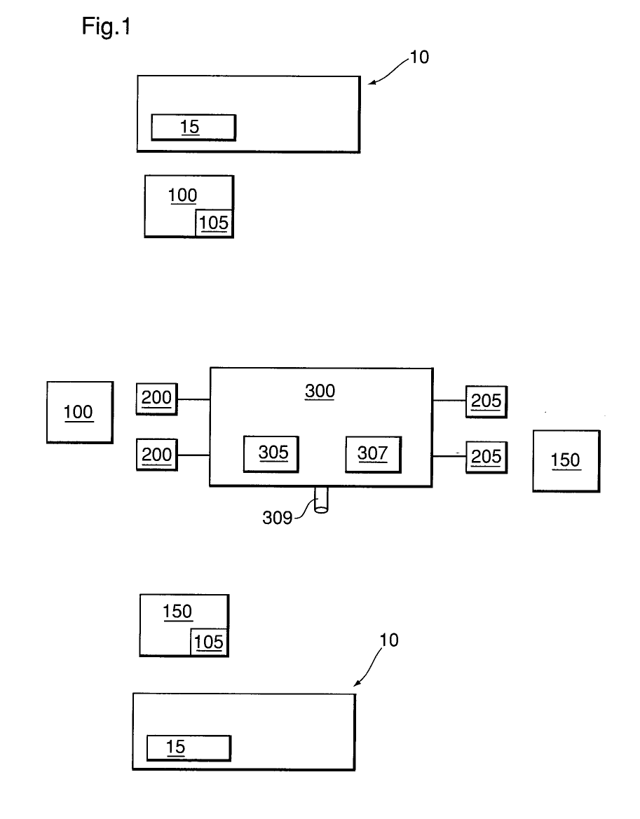

The water transfer connection 200 may be located near the mobile reservoir 100 or, as illustrated in FIG. 1, the mobile reservoir 100 may need to be repositioned for connection to the water transfer connection 200. After connection to the water transfer connection 200, the ballast water may be transferred to the water treatment facility 300. The water treatment facility 300 may comprise a ballast water storage reservoir 305, or alternatively may rely upon the mobile reservoir 100 for storage of ballast water before processing.

The ballast water may be treated according to a variety of water treatment methods known in the art Preferably the water treatment method provides for the separation of solids from the ballast water, the separation of oils from the ballast water and the neutralisation of contaminants such as nuisance species and/or dangerous substances. The neutralisation may be achieved by way of exterminating, sterilizing, damaging or otherwise rendering the contaminants in a state in which they cannot comprise invasive species or dangerous substances. Such neutralisation methods may include UV sterilisation, filtration, chemical, biological or environmental neutralisation or any other known method.

After treatment the treated water may be stored at the water treatment facility 300 in a treated water reservoir 307, or alternatively may be transferred directly to a mobile reservoir 150 for storage until subsequent transfer to a vessel 10 to add ballast. Depending upon local environmental regulations, it may also be possible to return the treated water to the environment through a discharge 309.

Where treated water is to be used as ballast, preferably treated water transfer connections 205 are provided to transfer the treated water from water treatment facility 300 to the mobile reservoir 150. In an embodiment the water transfer connections 200 and treated water transfer connections 205 may share a common location. In an alternative embodiment illustrated in FIG. 1, the water transfer connections 200 and treated water transfer connections 205 are located at different locations.

In an embodiment illustrated in FIG. 1, the water transfer connections 200 and the treated water transfer connections 205 are located at a water treatment facility 300 or mobile water treatment facility 350. Alternatively, the water transfer connections 200 and the treated water transfer connections 205 may be remotely connected to a water treatment facility 300 or mobile water treatment facility 350 by an extended connection, such as a pipeline. In a further embodiment the water transfer connection 200, 205 may comprise a connection to a local reservoir. In such circumstances, the ballast water may be transferred from the local reservoir to the treatment facility.

Alternatively, the water connection 200, 205 may comprise a land-based transport, such as a tanker truck. The tanker truck may then transport the ballast water by land to a treatment facility and transport treated water by land from the treatment facility. Where a land-based transport of limited volume is employed, the mobile reservoir may conveniently be used to store and sequester water while multiple trips using land-based transport are conducted to transport the required volume of water to or from the treatment facility.

Similar to the mobile reservoir 100, the mobile reservoir 150 may comprise water transfer equipment 105, such as a pump, for transferring ballast water from the mobile reservoir 150 to a ballast reservoir 15. Also similar to the mobile reservoir 100, the mobile reservoir 150 may comprise a self-propelled mobile reservoir, or alternatively, may comprise a non-propelled mobile reservoir that may be repositioned with the aid of a propulsion unit (not shown). In an embodiment the mobile reservoir 150 may comprise a barge that may be re-positioned with the aid of a self-propelled craft such as a tugboat.

After transferring treated water from the treated water transfer connection 205 to the mobile reservoir 150, the mobile reservoir may be positioned for connection to a ballast reservoir 15 on a vessel 10. After connecting the mobile reservoir 150 to the ballast reservoir 15, the treated water may be transferred to the ballast reservoir 15 to trim the vessel. In an alternate embodiment, the mobile reservoir 150 may receive water from some source other than the treatment facility 300 or mobile treatment facility 350.

Accordingly the mobile reservoir 100 provides for the flexibility to enable efficient handling of ballast water that accommodates standard vessel operations.

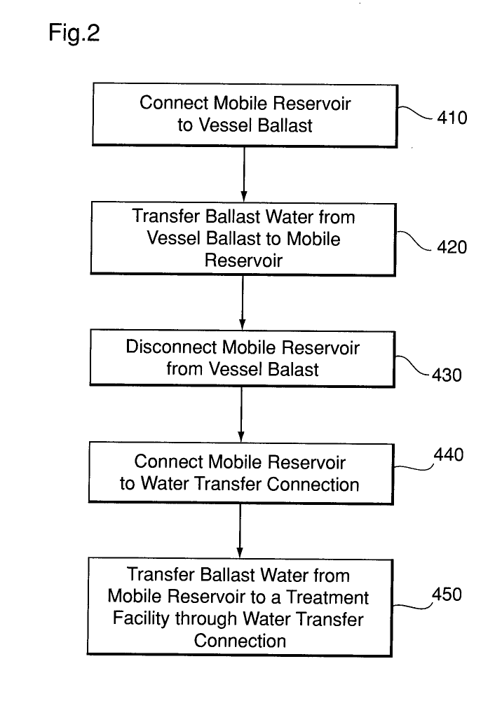

FIG. 2 illustrates a method for transferring ballast water from a vessel to trim the vessel. First a mobile reservoir is connected to a vessel ballast 410. Instead of discharging ballast water directly into the environment, as is currently the case, ballast water is transferred from the vessel ballast to the mobile reservoir 420. Since vessels are typically trimmed during the onloading and offloading of cargo, the use of a mobile reservoir allows the vessel to conduct efficacious trim operations in response to the timing of cargo transfer. Preferably the ballast water may be transferred to the mobile reservoir at a rate comparable to normal de-ballast discharge rates.

After the vessel has completed its trimming operations, the mobile reservoir is disconnected from the vessel ballast 430. As will be appreciated, in some circumstances the ballast water may be transferred directly to the mobile reservoir in a single step. In other circumstances, the ballast water may be transferred to the mobile reservoir in a series of steps over a period of time as dictated by the cargo loading schedule. In either case, the use of the mobile reservoir allows a vessel to conduct its trim operations at its own convenience, without consideration for the availability of a water treatment facility.

The mobile reservoir may then be connected to a water transfer connection 440 as indicated in FIG. 2. After connection the ballast water may be transferred from the reservoir to a treatment facility through the water transfer connection 450. The ballast water may be transferred at any convenient rate to the treatment facility. The transfer rate from the mobile reservoir to the treatment facility may be lower or higher than the transfer rate from the vessel ballast to the mobile reservoir.

Alternatively, the mobile reservoir may already be connected to a water transfer connection. In either case, the mobile reservoir provides for the sequestration of the ballast water to allow the vessel to transfer ballast water in accordance with its own operations. In certain circumstances it may be possible for the mobile reservoir to transfer the water directly to a treatment facility upon transfer from the vessel. In such circumstances, the mobile reservoir provides a standby storage facility to ensure that the vessel is able to transfer ballast water at its own schedule and to safeguard against discharge into the environment.

It will be appreciated that employing the mobile reservoir in a direct connection between the vessel and the water transfer connection permits a vessel to transfer water to the mobile reservoir at one rate and the subsequent transfer from the mobile reservoir to the water transfer connection at a second rate. The use of a dual rate transfer is advantageous as it permits the vessel to transfer ballast water in accordance with its trim operations, without regard to the capacity or flow rate limits of the treatment facility. For instance, the vessel may transfer ballast water at intermittent times at a first high transfer rate, while the mobile reservoir transfers ballast water to the water transfer connection at a steady second low transfer rate.

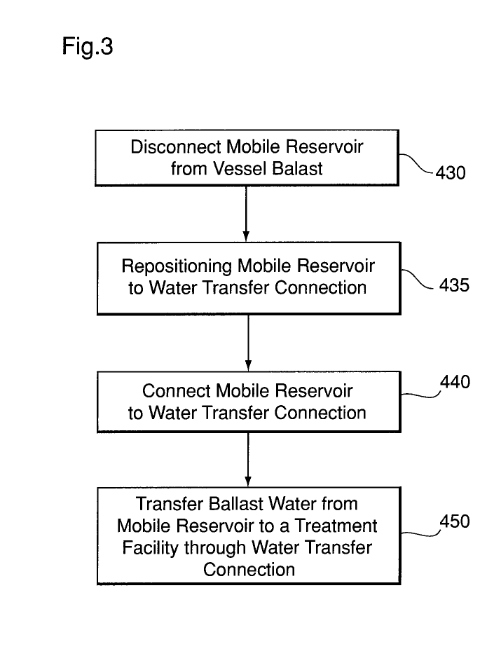

FIG. 3 illustrates an embodiment of the method whereby the mobile reservoir may be repositioned after transfer of the ballast water to the mobile reservoir 420. As illustrated, the mobile reservoir is first disconnected from the vessel ballast 430. The mobile reservoir may then be repositioned to a water transfer connection 435. The repositioning may either occur directly after disconnection from the vessel ballast, or may occur some time later. In either case, the mobile reservoir sequesters the transferred ballast water. After repositioning, the mobile reservoir is connected to the water transfer connection 440 and ballast water may be transferred from the mobile reservoir to a treatment facility through the water transfer connection 450.

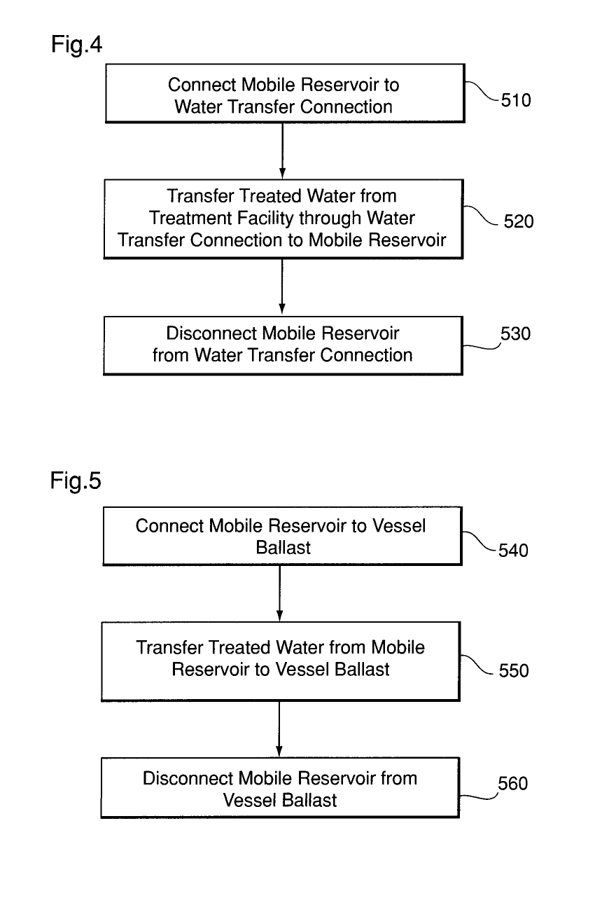

FIG. 4 illustrates the handling of treated water from a treatment facility. A mobile reservoir may be connected to a water transfer connection 510. Treated water may then be transferred to the mobile reservoir from the treatment facility through the water transfer connection 520, the mobile reservoir may then be disconnected from the water transfer connection 530.

FIG. 5 illustrates the transfer of treated water from a mobile reservoir to a vessel ballast. The mobile reservoir may be connected to the vessel ballast 540. The treated water may be transferred from the mobile reservoir to the vessel ballast 550 in accordance with the vessel trim operations. After completing trim operations the mobile reservoir may be disconnected from the vessel ballast 560.

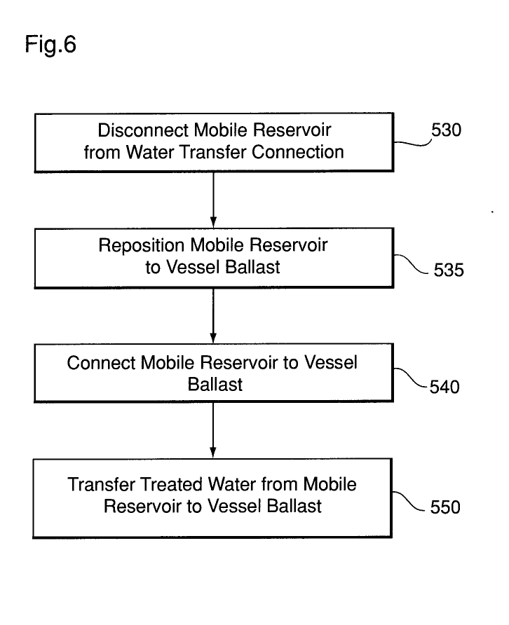

FIG. 6 illustrates an embodiment of the method whereby the mobile reservoir may be repositioned after transfer of the treated water to the mobile reservoir 520. As illustrated, the mobile reservoir is first disconnected from the water transfer connection 530. The mobile reservoir may then be repositioned to a vessel ballast 530. The repositioning may either occur directly after disconnection from the water transfer connection, or may occur some time later. In either case, the mobile reservoir sequesters the transferred treated water. After repositioning, the mobile reservoir is connected to the vessel ballast 540 and treated water may be transferred from the mobile reservoir to the vessel ballast 450 in accordance with the vessel trim operations. After transfer of the treated water to the vessel ballast the mobile reservoir may be disconnected from the vessel ballast 560.

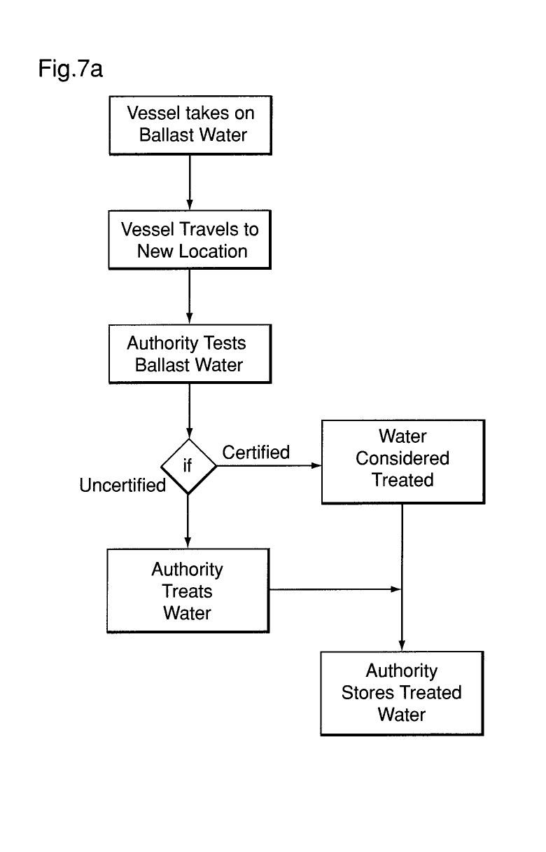

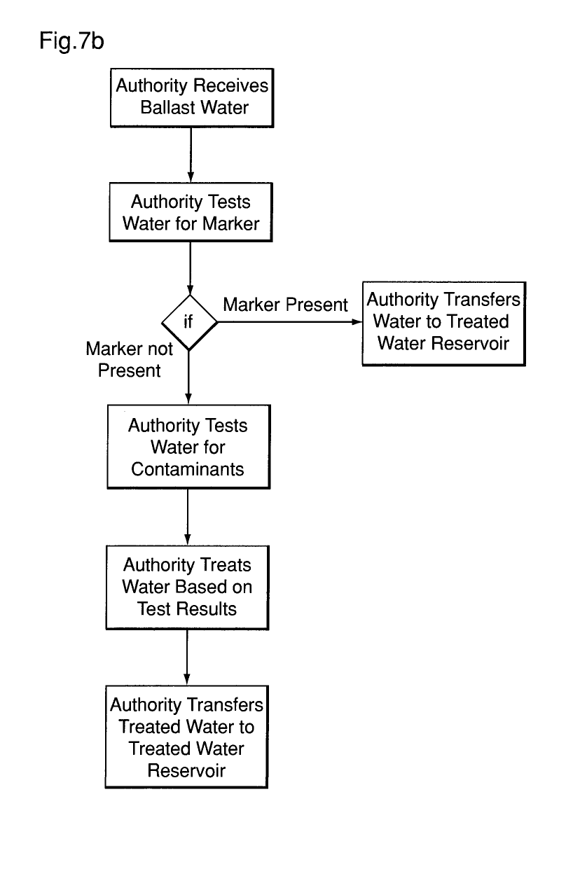

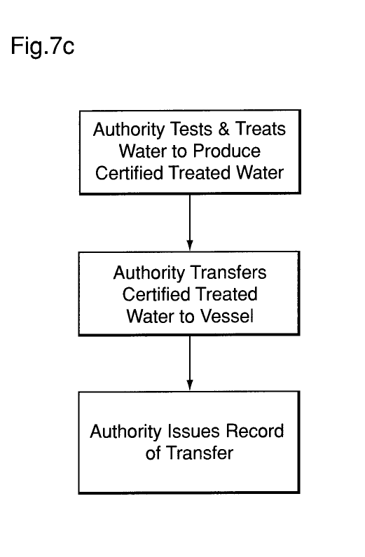

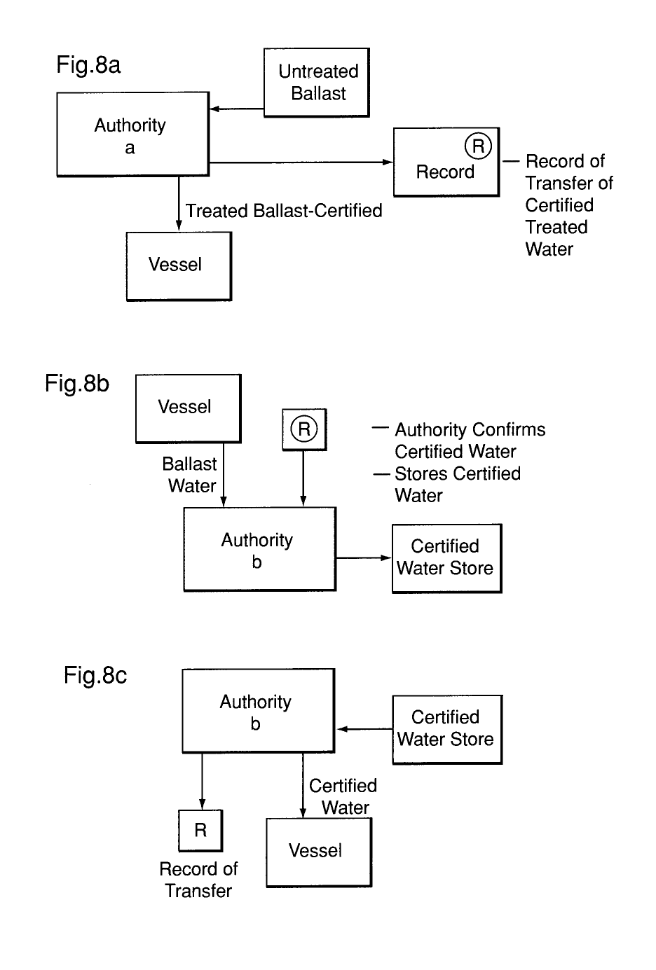

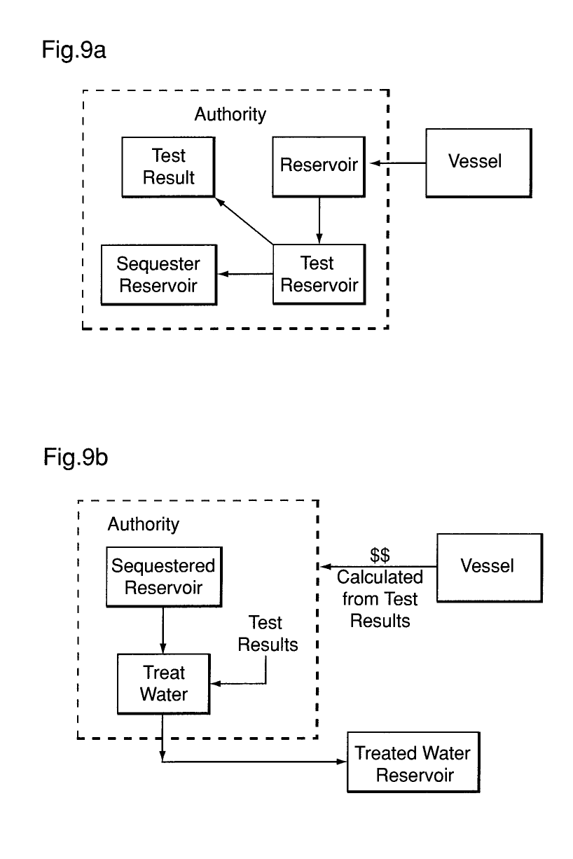

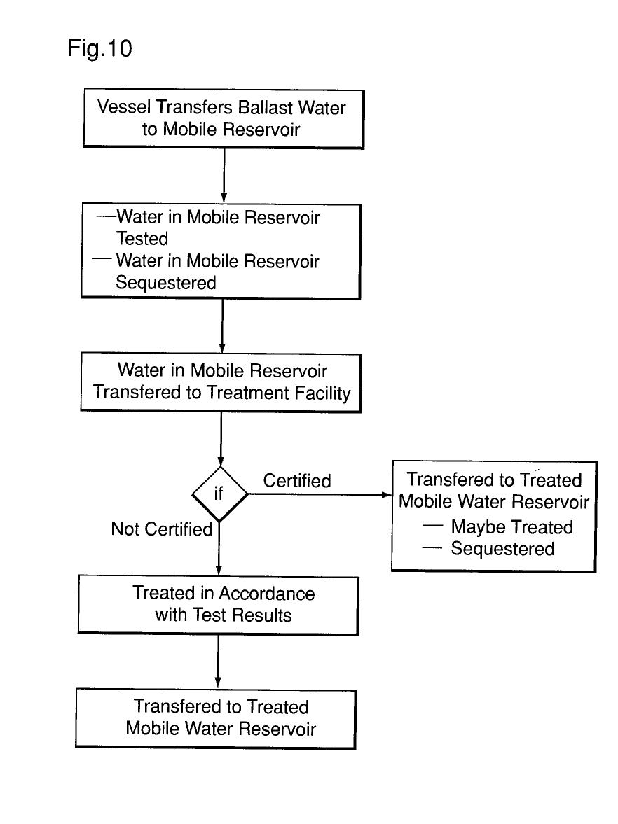

In an embodiment illustrated in FIGS. 7a-10, a method may be provided for handling ballast water between different authorities, including different ports, states or other organisations. In such a method vessel ballast water handling may be commoditized to provide revenue for handling, testing and treating ballast water.

In an embodiment a first authority may provide a vessel with ballast water by transferring treated water to the vessel to trim the vessel. Preferably the treated water comprises water that is certified by the authority as free from contaminants such as nuisance species or dangerous substances. The authority may seal the vessel ballast controls, or introduce a tracer or marker to the certified treated water. Preferably the tracer or marker is an inert non-toxic additive the presence of which may be inexpensively and accurately measured in the vessel's ballast water. Subsequent exchange or addition of ballast water will result in a detectable dilution or replacement of the tracer or marker in the ballast water.

Preferably a record may be created with the supply of certified treated water and comprises an identification of the first authority; the date, time and place of ballast transfer; the identity of the vessel; and, the volume of ballast transferred. Additional information such as the marker or tracer added to the treated water, the test results, or the individual's testing/certifying the treated water may also form part of the record.

When the vessel arrives at a destination a second authority may regulate its discharge or up-take of ballast water. In an embodiment the vessel may transfer its ballast water to a mobile reservoir to trim the vessel during cargo operations. The mobile reservoir provides storage and sequestration of the ballast water. The ballast water may be tested by the second authority, either while on the vessel or conveniently when sequestered in the mobile reservoir.

In an embodiment the second authority may also review a record supplied by the first authority to confirm the presence of treated water certified by the first authority.

The test may be directed to detecting a marker or tracer, or may more generally test for contaminants such as nuisance species or dangerous substances. In the case of the former, preferably the test will detect a level of the marker or tracer in order to confirm that additional ballast water was not taken up by the vessel during transit. In the event the marker or tracer is not present, or present in a diluted stated, the ballast water will be considered untreated water and subject to a full range of testing and treatment. In the event the marker or tracer is present at the expected level, the water may be considered to be water certified by the first authority as treated water and accordingly should meet the standards of the first authority. The second authority may either consider the first authority certified water as treated water, or may conduct its own testing and treatment. In an embodiment the second authority may conduct a limited range of testing and treating and rely upon the certification by the first authority that other contaminants are not present in the water.

If the first authority has supplied a record, the second authority may confirm the status of the ballast water by comparing the information in the record with the information in the vessel's log, the test results or other criteria as necessary.

Depending upon the outcome of the testing the second authority may treat the water to remove, eliminate or neutralise contaminants to produce treated water. Preferably the treated water may be sequestered in one or more treated water reservoirs. The second authority may also at this time introduce its own marker or tracer to identify the treated water as being certified by the second authority.

A vessel undergoing cargo operations within the jurisdiction of the second authority may receive treated water certified by the second authority. The second authority may provide water containing a marker or tracer and/or may seal the vessel's ballast controls. Preferably a record may be created with the supply of certified treated water and comprises an identification of the second authority; the date, time and place of ballast transfer; the identity of the vessel; and, the volume of ballast transferred. Additional information such as the marker or tracer added to the treated water, the test results, or the individual's testing/certifying the treated water may also form part of the record.

In the above described method of handling ballast water, the testing and treatment of ballast water may be monetized. The monetization of ballast water treatment allows vessel operators to pass on the cost of ballast treatment to their customers, and provides the funds necessary for states to provide ballast water handling facilities.

Accordingly treated water may be supplied to vessels by acquiring water, either confirming the water is free of contaminants or treating the water to provide treated water, and supplying the treated water to vessels. The water may be acquired by testing and treating ballast discharged by visiting vessels, receiving delivery of certified ballast water directly from another authority or drawing water from the local environment and testing and treating the local water to produce treated water. In all cases an authority preferably tests the treated water in order to certify the water as meeting the standards of that authority.

The monetization of the treated ballast water may occur by an authority charging fees for: receiving ballast water from vessels that need to discharge ballast; delivering treated water to vessels requiring ballast; and, delivering treated water to other authorities requiring additional treated ballast.

Preferably the fees may be calculated on a volumetric basis and scale according to the condition of the water being transferred. Accordingly a vessel that discharges uncertified water will pay more than a vessel that has certified water to discharge. Preferably fees may also scale depending upon the treatment required to remove, eliminate or neutralise contaminants in the water to be discharged. For instance a vessel that has contaminated its ballast water with fuel oil may pay an environmental penalty to cover the cost of separating, storing and disposing of any oil in the transferred ballast water. Similarly, vessels that conduct unauthorised exchange of ballast water within a water system may pay a penalty and may be required to “check-in” with all authorities within the water system in the future. Accordingly the method of handling ballast water provides a mechanism for enforcing the exchange and transfer of ballast water within a water system as well as between water systems.

As noted above, other vessel waste water may be handled by the described methods. Since waste water such as bilge water and sewage water typically require specialized treatment and handling, preferably they are handled separately from the large volumes of ballast water. Furthermore, treatment of waste water typically contemplates treatment and disposal as opposed to replenishment as required with ballast water.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. A method for removing ballast water to trim a vessel, the method comprising,
connecting a mobile reservoir in fluid connection with at least one ballast reservoir of the vessel;
transferring ballast water from the at least one ballast reservoir to the mobile water removal reservoir;
disconnecting the mobile reservoir from the at least one ballast reservoir; and,
testing the ballast water in the mobile water removal reservoir for contaminants;
whereby the transfer of ballast water from the at least one ballast reservoir trims the vessel.

2. The method of claim 1 further comprising after disconnecting the mobile reservoir from the at least one ballast reservoir, repositioning the mobile reservoir to a water transfer connection for connection.

3. The method of claim 2 further comprising after connecting the mobile reservoir to the water transfer connection, transferring the ballast water from the mobile reservoir to a treatment station for treatment.

4. The method of claim 3 wherein the water transfer connection is a mobile water transfer connection and further comprising repositioning the mobile water transfer connection for connection to the mobile reservoir.

5. The method of claim 3 wherein the treatment station is a mobile treatment station and further comprising repositioning the mobile treatment facility for transferring the ballast water from the mobile reservoir to the mobile treatment station for treatment.

6. The method of claim 1 further comprising the treatment station treating the ballast water for contaminants identified by the testing to produce treated water.

7. The method of claim 6 further comprising adding a tracer to the treated water to produce traceable treated water and transferring the traceable treated water to a second vessel.

8. A method for adding ballast water to trim a vessel, the method comprising,
connecting a mobile reservoir containing ballast water in fluid connection with at least one ballast reservoir of the vessel;
transferring water from the mobile reservoir to the at least one ballast reservoir; and,
disconnecting the mobile reservoir from the at least one ballast reservoir;
whereby the transfer of water from the mobile reservoir to the at least one ballast reservoir trims the vessel.

9. The method of claim 8 wherein the mobile reservoir contains treated ballast water.

10. The method of claim 9 further comprising filling the mobile reservoir with treated water at a water transfer connection and repositioning the mobile reservoir for connection to the vessel.

11. The method of claim 8 wherein the treated water is supplied to the water transfer connection by a water treatment station.

12. The method of claim 11 further comprising the water treatment station treating vessel ballast water to supply treated water to the water transfer connection.

13. The method of claim 10 further comprising,
transferring ballast water from a second vessel to a second mobile reservoir;
connecting the second mobile reservoir to a water transfer connection; and,
transferring the ballast water to the treatment facility for treatment;
whereby the ballast water transferred from the second mobile reservoir is treated for contaminants by the treatment station to provide treated water for supply to the mobile reservoir.

14. A system for handling vessel ballast water, the system comprising,
one or more mobile reservoirs for transferring treated ballast water to a vessel; and,
one or more ballast water transfer connections for fluid connection to the one or more mobile reservoirs to transfer treated ballast water to the one or more mobile reservoirs;
whereby the one or more mobile reservoirs may be positioned to transfer treated ballast water to the vessel.

15. The system of claim 14 further comprising at least one water treatment station in fluid communication with the one or more ballast water transfer connections for transferring treated ballast water.

17. The system of claim 15 wherein the at least one water treatment station comprises at least one of:
a liquid-solid separator for separating solid material from untreated ballast water, and a solids reservoir for storing the solids separated from the untreated ballast water;
a biological sterilizer for sterilizing, killing or eliminating biological matter in the untreated ballast water; and,
an oily water separator for separating oils from the untreated ballast water, and an oils reservoir for storing the oils separated from the untreated ballast water.

18. The system of claim 17 wherein the at least one water treatment station comprises at least one mobile water treatment station.

19. The system of claim 17 further comprising:
one or more mobile reservoirs for receiving untreated ballast water; and,
one or more treated water transfer connections for fluid connection to the one or more mobile reservoirs to transfer untreated ballast water from the one or more mobile reservoirs to the at least one water treatment station.

20. A method for handling ballast water used to trim vessels, the method comprising:
connecting a mobile reservoir in fluid connection with at least one ballast reservoir of a vessel;
transferring ballast water from the at least one ballast reservoir to the mobile water removal reservoir;
disconnecting the mobile reservoir from the at least one ballast reservoir;
repositioning the mobile reservoir to a water transfer connection for connection;
testing the ballast water for contaminants;
connecting the mobile reservoir in fluid communication to a water transfer connection for transferral to a treatment station;
transferring the ballast water to the treatment station; and,
treating the ballast water at the treatment station for contaminants identified by the testing to produce treated water.

21. The method of claim 20 further comprising:
transferring the treated water to a second mobile reservoir connected to a treated water transfer connection in fluid communication with the treatment station.

22. The method of claim 21 further comprising:
disconnecting the second mobile reservoir from the treated water transfer connection; and,
repositioning the second mobile reservoir for fluid connection to at least one ballast reservoir of another vessel; and,
transferring treated water from the second mobile reservoir to the at least one ballast reservoir of the another vessel.

23. A method of handling vessel ballast water, the method comprising:
a first authority transferring first authority certified water to a ballast of a vessel;
a second authority transferring ballast water from the vessel and verifying that the ballast water comprises first authority certified water.

24. The method of claim 23 wherein the first authority certified water comprises traceable water and the second authority tests the traceable water.

25. The method of claim 23 further comprising the first authority sealing the vessel's ballast controls and the second authority confirming the integrity of the seal.
